(19) United States
(12) Patent Application Publication
(10) Pub. No.: US 2002/0108058 A1
(43) Pub. Date: Aug. 8, 2002

(54) Anti-theft system for computers and other electronic devices

(75) Inventor: Ryuichi Iwamura, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Corporation and Sony Electronics Inc.

(21) Appl. No.: 09/779,860

(22) Filed: Feb. 8, 2001

(51) Int. Cl. G06F 11/30

(52) U.S. Cl. 713/201

(57) ABSTRACT

System and method for implementing a software based security system for preventing the unauthorized disconnection of electronic equipment from a network. A security system of the present invention includes at least one central processing unit, at least one piece of electronic equipment, a security station, and data transfer means for electronically interconnecting the at least one CPU, the at least one piece of electronic equipment, and the security station into a network. The CPU includes security software for detecting unauthorized disconnection of the electronic equipment from the network and sending an alarm signal to the security station. The software enabling a method embodiment for detecting the unauthorized disconnection of electronic equipment, including computers, from the network by determining whether the computers are logged on to the network, then polling each logged on computer. The logged on computers responding by sending an acknowledge signal which is sensed by the polling computer. In the event the acknowledge signal is not sensed, the polling computer sends an alarm signal to the security station.

### TECHNICAL FIELD

This invention relates generally to theft protection security systems and, more particularly, to a network security system for detecting the unauthorized removal of remotely located electronic equipment from a network.

### BACKGROUND OF THE INVENTION

There has been an ever increasing need to provide security for electronic equipment against the unauthorized removal or theft thereof. In particular, computer systems have become a major capital expenditure for businesses, educational institutions, governmental entities, as well as other users. Additionally, advancements in technology have significantly reduced the size and weight of complex computer equipment, thus making expensive computer equipment more easily portable. As a consequence, modem computer equipment is generally more compact and more easily transportable, which makes it more vulnerable to unauthorized removal or theft. The same can be said for other types of electronic equipment, e.g., televisions, DVD's, CD players, and a vast array of other electronic devices.

An added security difficulty is that modem computer network systems are frequently spread out over distant work areas. Such computer network systems generally include a number of remotely located work stations coupled via data communication links to a central processing center. For instance, many educational institutions, such as universities, provide many individual work stations scattered throughout the university campus so as to allow easy computing access to the computer network system. However, the wide dissemination of such equipment at remote locations has made the equipment an easily accessible target for computer thieves. Recent events at “secure” government research facilities have shown the urgent need for computer security.

Accordingly, a number of methods have been developed for guarding against the unauthorized removal of electronic equipment. Early methods of protection included physically attaching a security cord to each piece of protected equipment. However, the security cord can be cut or physically detached from its secured position and is usually considered to be a non-appealing aesthetic addition to the equipment. Another method of protection includes the attachment of a non-removal tag to the equipment which also requires cooperating sensing devices responsive to the tag which are properly located at exit locations from the premises. However, this approach requires rather expensive sensing devices and is generally not very feasible especially when multiple exit points exist.

Other methods of theft protection have included installing a special electronic card inside each computer machine which responds to polls from an external monitoring station. Upon removal of the machine, the card stops responding to the polling of the central station and an alarm is initiated. For organizations having a significant number of computing machines, the cost of these cards becomes prohibitively expensive. Furthermore, the time and effort wasted in installing these cards adds further costs to such systems. In addition the addition of yet another card to the machine is undesirable. Another approach involves mounting a sensing device on or into the machine to detect movement of the machines. These approaches are generally undesirable since they require the incorporation of additional components into each machine.

More recent methods of theft protection have included the sensing of a current loop coupled to the protected equipment. One such method is discussed in U.S. Pat. No. 4,654,640 issued to Carll et al. which discloses a theft alarm system for use with a digital signal PBX telephone system. This method includes a plurality of electronic tethers which are connected to individual pieces of protected equipment by way of connectors which in turn are bonded to the surface of the protected equipment. Each tether includes a pair of conductors which are connected together to form a closed current loop via a series resistor and conductive foil which is adhesively bonded to the outside of the equipment. Disadvantageously, this method requires an externally mounted current loop which can be carefully removed by a thief without any detection.

It is therefore desirable to provide for an enhanced network security system which detects the unauthorized removal of electronic hardware from a network. More particularly, it is desirable to provide for such detection without the need for additional hardware. It is also desirable to provide a detection system which is adaptable to a number of bus systems including wireless communications networks. Further, it is also desirable to provide a detection system which accomplishes polling in a manner that does not increase data traffic on other LAN's (local area networks). It is desirable to provide systems that do not require additional links to the outlying equipment but can rely on existing data communication links to monitor the presence or absence of linked equipment. In addition, it is desirable to provide a security system which is easily and inexpensively installed in an existing network system and which can not be physically removed. The embodiments of the present invention accomplish these and other goals.

### SUMMARY OF THE INVENTION

In one embodiment the present invention can be characterized as a system that detects unauthorized disconnection of electronic equipment from a network. Such a system includes at least one piece of electronic equipment, at least one central processing unit (CPU) having installed thereon security software for detecting the unauthorized disconnection of the at least one piece of electronic equipment, and at least one security station, all interconnected with a data transfer means to form a network. Such an embodiment can be used with data transfer means that include, but are not limited to, standard data lines, Ethernet.RTM. networks and 10BaseT lines, IEEE 1394 Serial Bus Standard digital network and wire data communication lines, telephone lines, fiber optic lines, and wireless communication apparatus. Such an embodiment can include electronic equipment such as televisions, stereo equipment, DVD's, VCR's or other electronic devices.

In another embodiment the system includes a CPU comprising a server computer interconnected to electronic equipment which includes at least one client computer. The server computer and the at least one client computer each having the security software installed thereon. As each at least one client computer is logged on to the network the security software of the server determines that the client computer has logged on and sends a polling signal, using the data communication means, to each of the at least one client computer which is logged on to the network. The logged on at least one client computer responds to the polling signal by sending an acknowledge signal. If the server computer does not sense the acknowledge signal from each of the logged on at least one client computer an alarm signal is sent to the at least one security station.

Another embodiment includes a network comprising a plurality of local server computers and a plurality of local client computers each having security software installed thereon. The plurality of local server computers and a plurality of local client computers are interconnected into a plurality of local area networks (LAN's) which are interconnected to each other, for example, using a plurality of bridges. Each LAN includes at least one local server computer and at least one local client computer. Each local server computer generates polling signals which are supplied to each logged on local client computer sharing the same LAN as the local server and furthermore can be supplied to other local servers on other LAN's. Such an embodiment provides security while minimizing the data traffic over the network caused by polling.

A further embodiment is employed in a system which includes at least one central processing unit (CPU) having thereon security software, at least one piece of electronic equipment, a security station, all interconnected using a data transfer means. The embodiment comprises a method for detecting the unauthorized disconnection of any electronic equipment from the network comprising the steps of connecting the electronic equipment to the network, logging the electronic equipment on such that the at least one central processing unit (CPU) recognizes that the electronic equipment is connected to and logged on to the network. The unauthorized disconnection of the electronic equipment from the network produces a disconnect signal. The at least one CPU senses the disconnect signal and sends an alarm signal to the security station in response to sensing the disconnect signal.

Yet another further embodiment is employed in a system which includes at least one client computer having thereon security software, at least one central processing unit (CPU) also having thereon the security software, a security station, all interconnected using a data transfer means. The embodiment comprises a software method for detecting the unauthorized disconnection of the client computers from the network comprising the steps of logging the at least one client computer on to the network and determining whether the at least one client computer is logged on to the network. Followed by the security software of the at least one CPU sending a polling signal to each at least one logged on client computer. The security software of at least one logged on client computer responds to the polling signal with an acknowledge signal, the security software receives the acknowledge signal from each polled client computer, the security software of the at least one CPU senses the acknowledge signal, and sends an alarm signal to the security station if the acknowledge signal is not sensed.

In an additional embodiment, principles of the present invention can be employed in a security system including: a plurality of local server computers (each including server security software), a plurality of local client computers (each including client security software), at least one security station, all interconnected into a network which includes a plurality of interconnected local area networks (LAN's), such that each of the plurality of LAN's includes at least one of the plurality of local server computers and at least one of the plurality of local client computers.

The embodiment comprises a method for detecting the unauthorized disconnection from the network of one of the plurality of local client computers or one of the plurality of local server computers. The method includes the steps of logging the plurality of local client computers onto the network, logging the plurality of local server computers onto the network, and determining whether the plurality of local client computers and local server computers are logged onto the network. The server security software of a first local server computer (or polling computer) on a first LAN sends a polling signal to one of the plurality local client computers sharing the first LAN, and also sends a polling signal to other local client computers sharing the first LAN and also sends a polling signal to each of the plurality of local server computers on the other LAN's. Each of the computers (local client or server) receiving the polling signal is collectively referred to as the polled computers. The client security software on the one of the plurality of local client computers and the server security software on the local server computers on the other LAN's generates, respectively, an acknowledge signal in response to the polling signal. This acknowledge signal is received by the server security software of the polling computer in acknowledgement that the polled computers are still connected network. Absent an acknowledge signal the server security software sends an alarm signal to the security station.

Other features of the present invention are disclosed or made apparent in the section entitled “DETAILED DESCRIPTION OF THE PREFERRED EMBODIMENTS.”

### BRIEF DESCRIPTION OF THE DRAWINGS

For a fuller understanding of the present invention, reference is made to the accompanying drawings in the following Detailed Description of the Invention. Reference numbers and letters refer to the same or equivalent parts of the invention throughout the several figures of the drawings. In the drawings:

FIG. 1 is a schematic illustration of an embodiment of a security system made in accordance with principles of the present invention.

FIG. 2A is a flowchart outlining a method embodying principles of the present invention.

FIG. 2B is a schematic time diagram illustrating a polling flow embodied by an embodiment of the present invention.

FIG. 3 is a schematic illustration depicting another embodiment of a security system made in accordance with principles of the present invention, having a plurality of interconnected LAN's.

FIG. 4 is a schematic illustration of a wireless embodiment made in accordance with the principles of the present invention.

FIG. 5 is a schematic depiction of a further embodiment for detecting theft of non-computer electronic equipment.

### DETAILED DESCRIPTION OF THE PREFERRED EMBODIMENTS

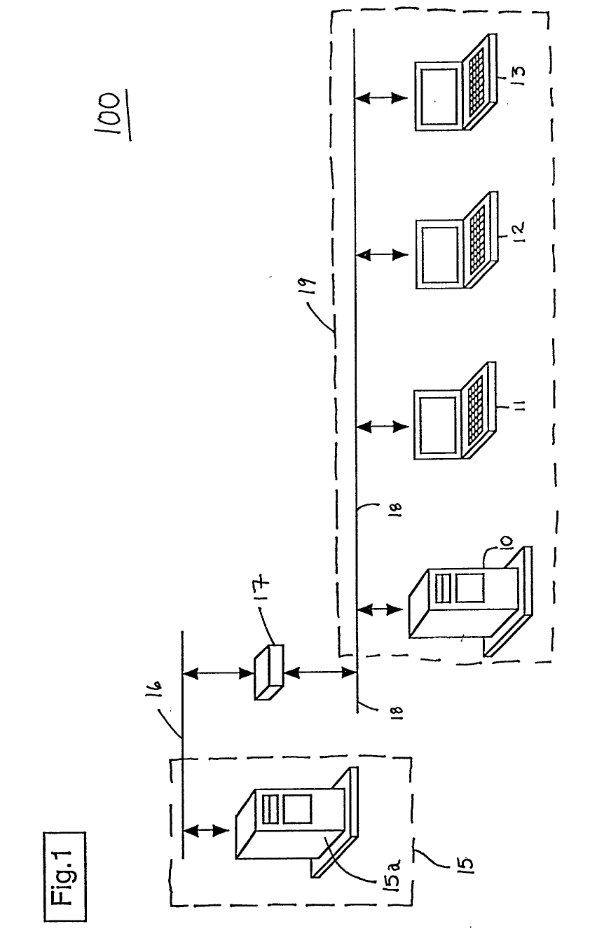

FIG. 1 illustrates a basic embodiment constructed in accordance with principles of the present invention. Such an embodiment includes at least one piece of electronic equipment 11, 12, 13, a server computer 10, and at least one security station 15, all of which are interconnected with a data transfer means 16, 17, 18. Such an embodiment comprises a security system 100. Integral to the operation of such a security system 100 is security software which is installed on the server computer 10 and on each of the at least one piece of electronic equipment 11, 12, 13. This security software can be installed as a single piece of software installed on both the server computer 10 and the at least one piece of electronic equipment 11, 12, 13. Alternatively, the security software can be broken into server security software installed on the server computer 10 and client security software installed on the at least one piece of electronic equipment.

FIG. 1 refers to a typical application of the present embodiment, which includes a server computer 10 (depicted here as a local server 10). In accordance with the present embodiment, the at least one piece of electronic equipment includes a plurality of client computers (e.g., laptop computers, desktop computers, or other work stations) 11, 12, 13. The security station 15 may include a security server computer 15a which will receive notification in the form of an alarm signal from the local server 10 that one of the client computers (e.g., 11, 12, 13) has been disconnected from the network without authorization. The security station 15 can be remotely located (even off premises) or in relatively close proximity to the local server 10 and client computers 11, 12, 13. The entire security system 100 is interconnected with a data transfer means which is schematically depicted as 16, 17 and 18. Examples of satisfactory data transfer means may include, without limitation, standard data transmission lines, such as wire data communication lines, telephone lines or fiberoptic lines, an Ethernet.RTM.network with 10 Base T Lines, an IEEE 1394 Serial Bus Standard digital network, bridges, routers, or other suitable data transmission devices known to those having ordinary skill in the art, e.g., network cards and wire data transmission lines. The data transfer means can also include wireless communication systems. As depicted, the data transfer means includes a bridge 17, a first network cable 16 and a second network cable 18. The bridge 17 interconnects a local area network (LAN) 19 (including the server computer 10 and client computers 10, 11, 12, 13, and the second network cable 18) to a first network cable 16, which in turn is connected to the security station 15.

It should be noted that the connection to the security station 15 can be accomplished using a number of different modes known to those having ordinary skill in the art. For example, the bridge 17 and the first network cable 16 and second network cable 18 can be replaced by a simple modem and telephone line to interconnect the security station 15 to the local server 10.

Server security software system installed on the local server 10 and client security software in each of the client computers 11, 12, 13 enable the detection of an unauthorized disconnection of the client computers from the system as explained below. The server security software determines whether the client computers 11, 12, 13 are logged on to the network (in this case the LAN 19). “Logged on” as defined herein refers to the process of electronically connecting one of the components of the network (e.g., client computers or server computers) to the network or the LAN using a secure means such as an electronic key or password. The server security software includes means for determining if a given client computer 11, 12, 13 is logged on to the network 19. The determining means comprises software means for generating a polling signal that is supplied to the client computers 11, 12, 13 from the local server 10 via the data transfer means 16, 17, 18. The client security software of the client computers 11, 12, 13 includes means for responding to the polling signal. The responding means responds to the polling signal with an acknowledge signal. The client security software transmits the acknowledge signal via the data transfer means 16, 17, 18 to the local server 10. The local server 10 receives the acknowledge signal and the server security software, which includes a means for receiving the acknowledge signal from each logged on client computer 11, 12, 13 confirms that each client computer 11, 12, 13 is still properly logged on to the LAN 19. The server security software also includes a means for sending an alarm signal to the security station 15 in the event that no acknowledge signal is received from the logged on client computers 11, 12, 13 within a prescribed timeout (or watchdog) period in response to polling.

For example, a user connects the client computer 11 to the LAN 19 and the client security software is installed on the client computer 11. The user will run the client security software and log on with a password. The client security software on the client computer 11 sends a computer name identifying client computer 11 and the password to the local server 10. The security software of the local server 10 adds the computer name and the password to a polling list. Then, according to the security software of the local server 10, the local server 10 polls all the client computers 11, 12, 13 one after another. All computers still connected to the local server 10 will send the appropriate acknowledge signal back to the local server 10. When the user wants to disconnect the computer 11 from the LAN 19 (i.e., “log off”), the password is reentered. The client security software of the client computer 11 sends its computer name and the password to the local server 10. The security software of the local server 10 refers to the polling list. If the password sent from the client computer 11 is the same as the logon password, the local server 10 recognizes it as an authorized logoff and the local server 10 will not send an alarm signal to the security station 15. If the password does not match, the security software will know that an unauthorized log off is being attempted and an alarm signal will be sent to the security station 15. Furthermore, if the client computer 11 is simply disconnected from the local server 10, the client computer 11 will fail to respond to the polling signals sent from the local server 10 and the security software of the local server 10 will transmit an alarm signal to the security station 15.

In an alternative embodiment for detecting when a user is legally attempting to log off, all of the computer names corresponding to respective ones of the computers 11, 12 and 13 and the passwords are registered and stored in the local server 10. At log on, only the computer name is sent, not a password. At log off, the password is sent from the client computer to the local server and compared to the stored password in order to detect if the log off is authorized. This alternative method is more secure since the password is transmitted to the local server 10 less frequently, making the password more difficult to steal or intercept.

Thus, as described above, this embodiment provides a software-based polling solution that is cost effective and flexible in comparison to conventional hardware-based polling solutions. Instead of physically installing hardware into each client computer and each local server, software is installed. This software may be loaded directly into a respective computer via a storage medium (e.g., CD or disk) or may be downloaded from the local server 10 to the client computers 11, 12 and 13 or downloaded from a remote server in a computer network (e.g., the Internet) coupled to the local server 10. A software-based solution is also very flexible and can be adapted to changes in LAN 19 configuration. For example, network layout changes often, with computers being added and removed from the network. In contrast, hardware-based solutions (e.g., installing cards to each computer 11, 12, 13 and the local server 10) requires physical installation at each connected computer. Furthermore, a new computer added to the LAN 19 would require a security card installed as well. If advances were made to such a hardware-based security system, the cards installed on all of the computers would have to be removed and replaced with replacement cards (or other hardware) to update the system. Further advantages of several embodiments of the software-based polling solution are described further below.

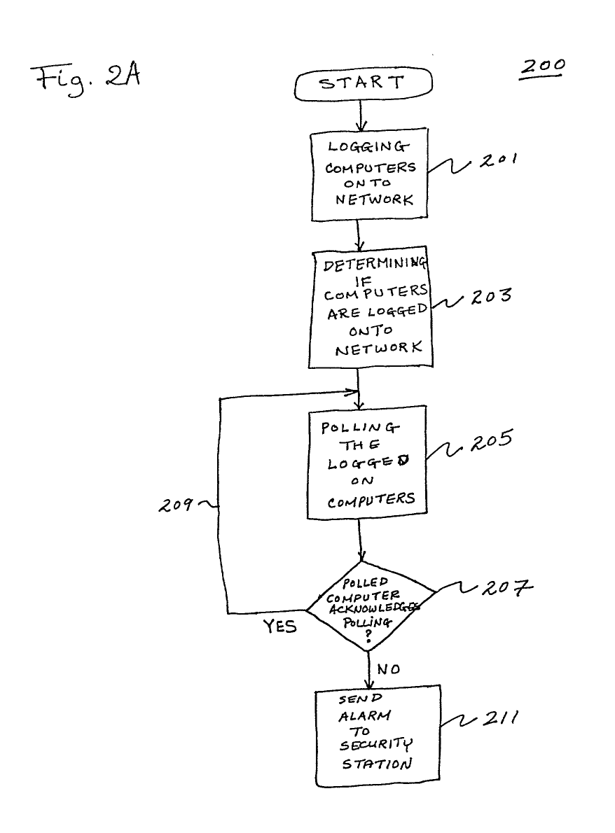

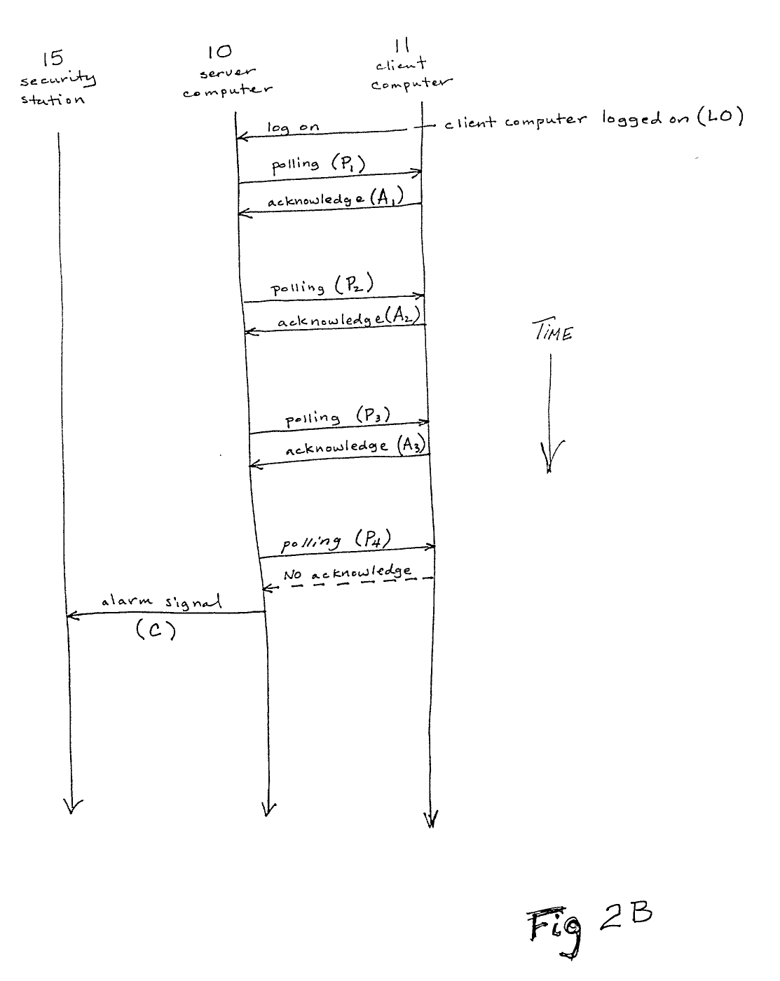

FIG. 2A is a flowchart which describes a method of detecting the unauthorized disconnection of electronic equipment (e.g., a client computer) from a network such as might be incorporated into a software embodiment 200. A first step optionally includes logging client computers onto a network (Step 201). However, it is not necessary that client or server security software be capable of logging client computers onto the network, only that the client and server security software be capable of determining whether a client computer is logged onto the network (Step 203). Once a client computer is determined to have been logged on, the server security software directs the local server to poll each logged on client computer (Step 205). For example, as each client computer is logged on it is entered into a polling list which tracks all the logged on systems (this polling may be expanded, further discussion is included below). The server security software then polls each computer on the list, awaits a response, then moves on to the next client computer on the list. This list is repeatedly polled at predetermined time intervals. This list is continuously modified as computers log on and log off. In any event, other polling schemes may be used as long as each logged on computer is polled periodically.

Client security software installed on the client computers receives the polling signal, responding with an acknowledge signal (Step 207). The local server awaits (during a prescribed timeout period) the acknowledge signal from each of the polled client computers. If the local server receives an acknowledge signal from a polled client computer, it confirms the computer is still logged on and connected to the network. At which point the server polls the next client computer on the logged on list. The polling of the client computers on the logged on list repeats at intermittent time intervals, e.g., after a predetermined time interval (e.g., two minutes) each of the logged on systems on the list are polled again (Step 209). This process of determining which systems are logged on, polling the logged on computers, acknowledging the polling, and receiving the acknowledged signal is repeated again and again until the client computers are appropriately logged off at which point they are no longer polled. If the local server does not receive an acknowledge signal from a logged on, polled, client computer within a prescribed timeout period or watchdog period, the server alerts the security station by sending an alarm signal which can also identify which client computer has been disconnected (Step 211), at which point security personnel become alerted to the fact that an unauthorized disconnection of a particular client computer has occurred. Security personnel will then take appropriate action. Additionally, the local server can emit an audible alarm, either in conjunction with or independent of sending the alarm signal to the security station.

Advantageously, the polling traffic is kept to a minimum since the polling signals are sent infrequently, e.g., each computer is polled every 1 to 2 minutes. This polling traffic, e.g., polling signals and acknowledge signals, is very short; therefore, the polling traffic of this embodiment does not interfere with the regular flow of data between the local server 10 and the client computers 11, 12 and 13.

An alternative polling technique that may be used in Steps 205, 207, 209 and 211 is “round robin” polling in which the local server 10 directs client computer 11 to send a polling signal to client computer 12 when client computer 11 receives a polling signal from the local server 10. The local server 10 also directs client computer 12 to send a polling signal to client computer 13 when client computer 12 receives a polling signal from client computer 11. And the local server 10 also directs client computer 13 to send a polling signal to the local server 10 when client computer 13 receives a polling signal from client computer 12. Thus, the polling signal that was sent from the local server 10 is relayed between local computers 11, 12 and 13 one after another and returns to the local server 10. If the polling signal does not return within a specified time, the local server 10 will be in alarm mode in which the local server 10 then directly polls each client computer to determine which client computer is illegally disconnected. If, for example, client computer 12 legally logs off, the local server 10 will direct the client computer 11 to forward the polling signal to client computer 13, instead of client computer 12, so that client computer 12 is skipped. Advantageously, this round robin polling technique reduces the total access number. If the number of client computers is n, a regular polling technique requires 2n transactions, i.e., sending a polling signal and receiving an acknowledge. In contrast, this round robin technique only requires n transactions since each client computer sends the polling signal to the next client computer or back to the local server 10 if the client computer is at the end of the line. Although this reduces the transactions, the local server 10 must let each client computer know where to send to the polling signal to at the beginning of the polling process. Furthermore, the local server 10 must also send a new destination to the respective client computers when one or more of the client computers legally logs off.

FIG. 2B shows the principles of the present invention using a time diagram. A security station 15, a server computer 10, and a client computer 11 are shown. Once the client computer 11 is logged onto the network it, for example, goes onto a server computer 10 polling list. The polling list may be stored in the memory of the server computer 10. After some time interval set by the user, the server computer 10 polls the client computer 11 using the server security software to generate a polling signal P₁. The polling signal P₁ is detected by the client security software of the client computer 11, which responds with an acknowledge signal A₁. The acknowledge signal Al indicates to the server security software that the client computer 11 is still connected to the network. At periodic intervals (shown here by P₁, P₂, P₃, P₄) further polling occurs. Such polling continues at periodic intervals until the client computer 11 is disconnected from the network. The client security software of the connected client computer 11 acknowledges each polling signal (Pₙ) with an acknowledge signal (Aₙ) until a correct password (or other security protocol) is entered and the client computer 11 is logged off. At such time the client computer 11 is no longer polled. The polling list may be updated to reflect the authorized log off of the effected client computer 11.

However, in the case where an unauthorized disconnection of a client computer 11 occurs, the server security software alerts the security station 15. For example, at some time after the last acknowledge signal (A₃), an unauthorized disconnection of the client computer 11 takes place. The disconnected client computer 11, not having been taken off the polling list by a correct (authorized) log off procedure, is subsequently polled (P₄) by the server security software of the server computer 10. Because the client computer 11 has been disconnected, no acknowledge signal is sent by the client security software or received by the server security software. If, after a prescribed time period, no acknowledge signal is received by the server security software, the server security software generates an alarm signal C which is sent to a security station. As a result appropriate action can be taken. Although this discussion is based on a network including only one server computer, one client computer and one security station, it is contemplated that similar embodiments can be used on systems including a plurality of servers, a plurality of client computers and a plurality of security stations.

In addition to the polling of the client computers, the server computers can also poll other server computers in a larger network as discussed below. In this way the plurality of server computers can be monitored and their unauthorized removal from the network can also be detected.

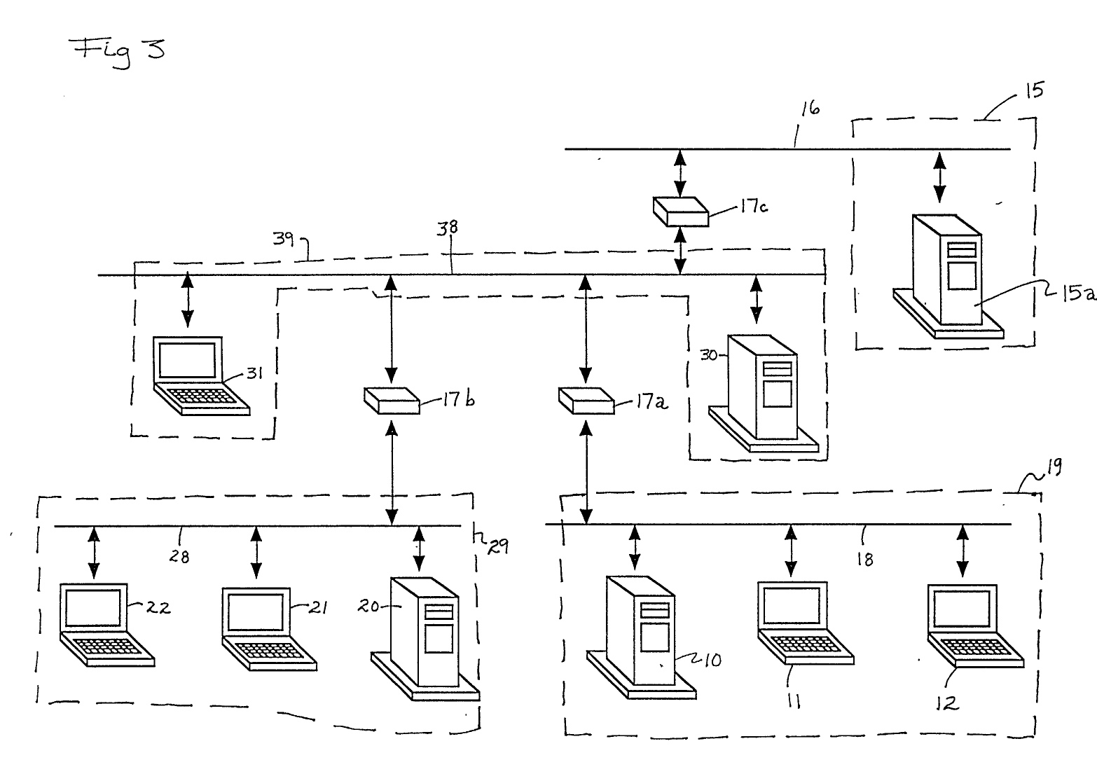

FIG. 3 shows an embodiment which includes several interconnected local area networks (LAN's). For example, several interconnected LAN's 19, 29, 39 and their interconnections comprise a data transfer means (17a, 17b, 16, 18, 28, 38), similar to the data transfer means described above in reference to FIG. 1. A first LAN 19, including a first local server 10 and first plurality of local client computers 11 and 12 is interconnected to a third LAN 39 using a first bridge 17a. Similarly, a second LAN 29 includes a second local server 20 and a second plurality of local client computers 21 and 22. The second LAN 29 is interconnected to the third LAN 39 through a second bridge 17b. The third LAN includes a third local server 30 and third local client computer 31 and is interconnected to the first LAN 19 and the second LAN 29 via the first bridge 17a and second bridge 17b, respectively. The security station 15 includes the security system server 15a and is interconnected to the third LAN 39 via a third bridge 17c. Such a configuration allows each LAN to monitor its own local client computers 11, 12, 21, 22, 31 and/or the local servers 10, 20, and 30 and the security server 15a to monitor each other in the event that they subject to unauthorized disconnection. One of the drawbacks of previously known systems is that the continuous polling and acknowledgment bog down the systems with excessive data traffic, particularly through the bridges 17a, 17b, 17c. The present embodiment solves this problem in that the local servers 10, 20, 30 poll and receive acknowledgment signals only from the local client computers on the their own LAN 19, 29, 39. For example, the first local server 10 on the first LAN 19 polls only the first plurality of local client computers 11 and 12 on the first LAN 19. Similarly, the second local server 20 on the second LAN 29 polls only the second plurality of local client computers 21 and 22 on the second LAN 29. Also, the third local server 30 on the third LAN 39 polls only the local client computer 31. The bridges 17a and 17b can be configured to prevent polling of, for example, the third local client computer 31 on the third LAN 39 by the first local server 10 or the second local server 20. In cases where there are even more LAN's, the bridges prevent local polling signals from being sent to another LAN. The bridge helps to keep the number of packets being passed from one LAN to another to a minimum by acting as a filter. In contrast, a repeater (instead of a bridge) passes all data packets from one LAN to another without discretion. The bridge detects a header in a data link layer and based upon the header, the bridge decides whether or not to pass the data packet. Usually, a bridge connects two LANs. So configured, the bridge (e.g., bridge 17a) prevents internal communication in one LAN (e.g., LAN 19) from being transmitted to another LAN (e.g., LAN 39) that is connected via the bridge. Thus, if a first LAN is currently transferring large amounts of data, a second LAN coupled to the first LAN is not bogged down by the traffic of the first LAN since the bridge will block data packets within the first LAN from being transferred to the second LAN. Thus, advantageously, all local polling signals are blocked by a bridge. Consequently, by way of example, the third local server 30 on the third LAN 39 polls and receives acknowledgments only from the third local client computer 31 on the third LAN 39.

However, in some embodiments, it is preferred that the local servers 10, 20, 30 poll and receive acknowledgments from each other, through the bridges 17a and 17b. For example, local server 30 polls local servers 10 and 20, or local server 10 polls local servers 20 and 30. Thus, the only cross-bridge traffic is the polling of the local servers 10, 20, 30 and acknowledgments from the polled local servers 10, 20, 30 to the respective polling local servers 10, 20, 30. No polling of the local client computers 11, 12, 21, 22, 31, or acknowledgment from local client computers 11, 12, 21, 22, 31 passes the bridges 17a, 17b. Furthermore, the security server 15a polls all the local servers 10, 20, 30.

Alternatively, a local server which is closer to the security server 15a may poll another local server located further from the security server 15a in a hierarchical fashion. For example, the security server 15a polls local server 30 only while local server 30 polls local servers 10 and 20 (note that each of the local servers 10, 20, 30 continue to poll their respective client computers). As such, within the computer network as a whole (i.e., the security station 15 and LANS 19, 29, 39), the amount of polling traffic is reduced since local servers are polled in a hierarchical fashion. Thus, the security server 15a does not have to poll hundreds (or thousands) of computers, the security server 15a only polls one local server. Additionally, local server 10 may be viewed as a lower level server while local server 30 may be viewed as an upper level server and each local server polls the computers coupled to it, not those computers of the other LANs. Thus, advantageously, the polling traffic is greatly reduced.

Should any local server 10, 20, 30 or local client computer 11, 12, 21, 22, 31 become disconnected from the network, such disconnection is detected by the server security software of the appropriate local server 10, 20, 30 and an alarm signal is generated by the local server 10, 20, 30 and sent to the security server 15a (presumably in a security office). The alarm signal can also include information precisely identifying the disconnected computer and its last known physical location, thereby enabling security personnel to locate the disconnection and act accordingly. Alternatively, or additionally, the polling server computers 10, 20, 30 can emit an alarm signal.

As explained briefly above the polling between the local servers 10, 20, 30 can be configured such that each of the local servers 10, 20, 30 polls each other local servers 10, 20, 30 connected to the network across the bridges 17a, 17b. For example, the first local server 10 may poll the second and third local servers 20 and 30. The second local server 20 may poll the first and third local servers 10 and 30, etc. Alternatively, server polling can proceed in a “round robin” fashion, for example, the first local server 10 polls the second local server 20, the second local server 20 polls the third local server 30, and the third local server 30 polls the first local server 10 and so on. In this way, the disconnection of any one of the local servers 10, 20, 30 is detected immediately and the alarm signal sent to the security server 15a.

Each of the previously discussed embodiments has the advantage of not requiring additional hardware in the local servers and the local client computers to enable the security system. The installation of software in many client and server computers is a much easier and cost effective solution than installing new hardware on many computers. In addition, a software solution has much more flexibility over a hardware solution and allows for easy additions to a network. Instead, the described embodiments incorporate low cost security software which may be installed as a single program onto both server and client computers or as separate server security software and client security software which can be installed on each local server and local client computer of a computer network, respectively. Either way, such a solution can be implemented at a fraction of the cost and in a fraction of the time of hardware based solutions. Only the security server and optionally an appropriate CPU and/or inter-connection are added as hardware components. Advantageously, there is also much less data being sent over the network (e.g., security station 15 and LANs 19, 29, 39 collectively) less frequently. This helps to keep the network from being bogged down by the polling of the security system. Additionally, a software system can implement a hierarchical structure, where local servers (e.g., local server 10) only send alarm signals to a main server (e.g., local server 30) which forwards the alarm signal to a security server when an unauthorized disconnection has been made. The main server only has to poll the local server and not hundreds or thousands of client computers on the network. This helps to minimize the polling traffic that is sent over the network.

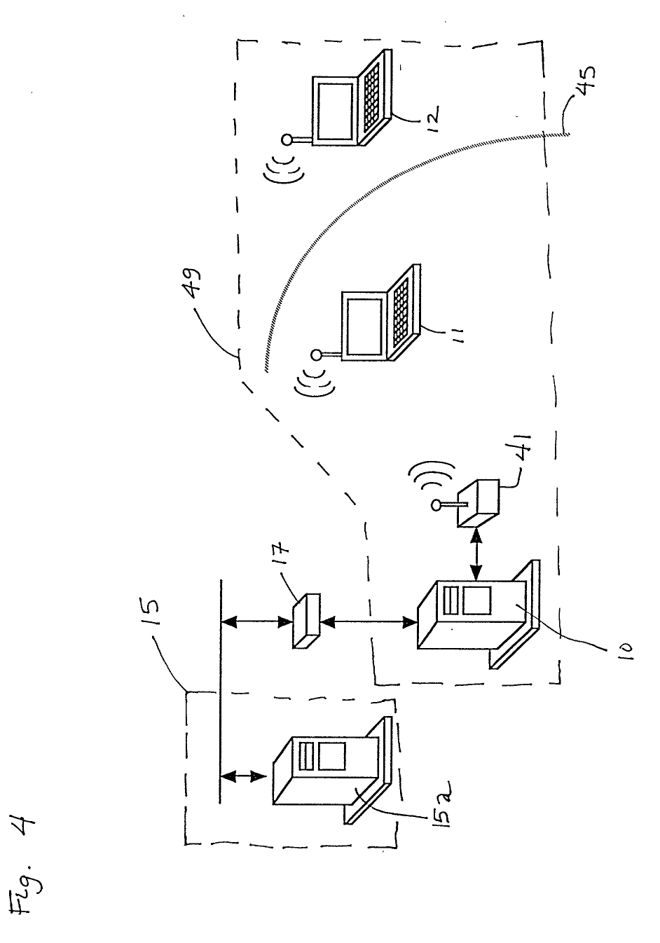

Another advantageous embodiment is illustrated in FIG. 4. The example system of FIG. 4 shows a single LAN 49 connected to a security station 15. The security station 15 includes a security server 15a which is connected to at least one local server 10 (depicted here as a single local server 10) of the LAN 49. This interconnection can be accomplished through a variety of means known to those with ordinary skill in the art. The pictured example interconnects the local server 10 to the security station 15 using a bridge 17. Also, the local server 10 is interconnected to a plurality of client computers 11, 12 using a wireless local area network (LAN). This can be accomplished through a variety of wireless systems (e.g., Blue Tooth™ or other wireless formats can be used). For example, the local server 10 may include a wireless interface 41 and the client computers 11, 12 also each include a wireless interface. As with the wired embodiments, the client computers 11, 12 log onto the LAN 49, alerting the local server 10 to their connection to the LAN 49. The local server 10 then polls each client computer 11, 12 via the wireless interface 41 much the same way as for wired embodiments. In the event of attempted theft, the misappropriated client computer will be carried from its current location to another location which will be outside the range of the wireless interface 41 (shown here schematically by the broken line 45). Once outside the range 45 of the wireless interface 41 the acknowledge signal can no longer be received by the local server 10 (and/or the polling is no longer received by the misappropriated client computer), thus prompting the local server 10 to send an alarm signal to the security station 15 alerting the security server 15a that a misappropriation has occurred and identifying the particular misappropriated client computer. Furthermore, a discontinuation of power (due to unplugging) results in the inability of the misappropriated client computer to transmit an acknowledge signal, thus causing the local server 10 to alert the security server as described above.

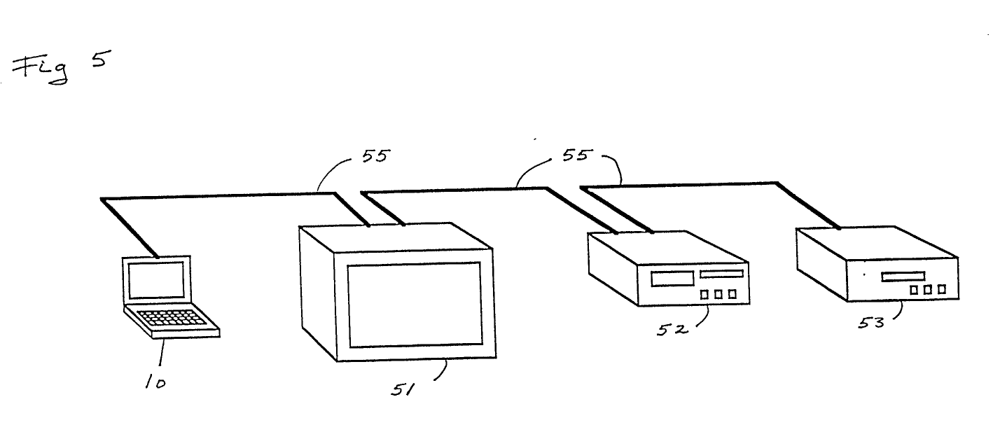

In yet another significant embodiment, no polling is used at all. Furthermore, the electronic equipment need not be computers. Some networks that have a plug/unplug detection capability do not require polling (IEEE 1394 network is a typical example). As depicted in FIG. 5, the electronic devices 51, 52, 53 can be, for example, non-computer electronic devices such as, home electronic devices including, without limitation, televisions, VCR's, DVD players or a variety of stereo or hi-fi products. A computer (e.g., a desktop computer or a laptop computer) 10 operates as the master device and is interconnected with the electronic devices 51, 52, 53.

A preferred embodiment interconnects the devices 51, 53 using an IEEE 1394 (i.Link) 55, as known in the art. Such networks are discussed in detail in U.S. Pat. No. 5,883,621 to Iwamura which is hereby incorporated by reference. The Institute of Electrical and Electronic Engineers (IEEE) has promulgated a number of different architecture standards, including IEEE standards document 1394, entitled “Standard for High Performance Serial Bus” (hereinafter “1394 Bus”). A typical 1394 Bus comprises many nodes interconnected by point-to-point links, e.g., cables, that connect one node to another. A typical node is established at each piece of electronic equipment connected to the network. Data transported along a IEEE 1394 serial network reaches every node in the network, thereby allowing each “system” connected to the network to be in contact with (in this case) the computer 10. In such applications the electronic devices are “logged in” or “logged out” at the computer 10. The user will enter, for example, each device (51, 52, 53) by name and enter a password at the computer 10. The user also logs each device out at the computer 10 using the password before disconnection. In the case of a IEEE 1394 serial network, the computer 10 does not need to poll the devices (51, 52, 53). This is because whenever a device 51, 52, 53 is disconnected an automatic reset occurs. A connected device will supply a 1.0 vdc bias voltage. When the device is disconnected this voltage will drop to 0.6 vdc voltage, below a 0.8 vdc reference voltage. This will trigger a reset and a signal will be sent across the bus due to the detected change in the bias voltage. This reset is automatically detected by the computer 10, and if the device is disconnected without entry of a log off password, the computer 10 sends an alarm signal to a security station (not shown). After the bus reset, the computer 10 detects all the connected devices. By comparing with the device list before the bus reset, the computer 10 identifies which device has been disconnected and sends this information to the security station. The alarm signal can be sent over telephone line, Internet, additional IEEE 1394 lines, or any other data transmission means.

The security station can be very remote from the computer 10 and devices 51, 52, 53. This embodiment presents excellent opportunities for application of this embodiment for home security. The security station could be at a police station or at a private security office and connected via the internet. An alternative application is, for example, at a trade show, where the devices 51, 52, 53 are hooked up in a display, which presents ready opportunities for theft. By connecting the devices 51, 52, 53 to a portable computer 10, which is connected to, for example, the trade show security office, a fully transportable, highly effective, security system has been provided.

The present invention has been particularly shown and described with respect to certain preferred embodiments and features thereof. It is to be understood that the shown embodiments are the presently preferred embodiments of the present invention and as such are representative of the subject matter broadly contemplated by the present invention. The scope of the invention fully encompasses other embodiments which may become obvious to those skilled in the art, and are accordingly to be limited by nothing other than the appended claims, in which reference to an element in the singular is not intended to mean “one and only one” unless explicitly stated, but rather “at least one” or “one or more”. All structural and functional equivalents of the elements of the above-described preferred embodiment that are known or later come to be known to those of ordinary skill in the art are expressly incorporated herein by reference and are intended to be encompassed by the present claims. Moreover, it is not necessary for a device or method to address each and every problem solved by the present invention, for it to be encompassed by the present claims. Furthermore, no element, component, or method step in the present disclosure is intended to be depicted to the public regardless of whether the element, component, or method step is explicitly recited in the claims.

I claim:

1. A security system for detecting unauthorized disconnection of electronic equipment from a network, the security system comprising:
at least one central processing unit (CPU);
at least one piece of electronic equipment;
a security station;
data transfer means for electronically interconnecting the at least one CPU, the at least one piece of electronic equipment, and the security station;
the CPU including security software for detecting unauthorized disconnection of the electronic equipment from the network and sending an alarm signal to the security station.

2. The security system as in claim 1 wherein the at least one CPU comprises a computer having a computer network card which together with data transmission lines form the data transfer means.

3. The security system as in claim 1 wherein the security station comprises a remotely located security station and the data transfer means further includes a modem and at least one telephonic data transmission line for connecting the CPU to the security station.

4. The security system as defined in claim 1 wherein the at least one piece of electronic equipment includes at least one non-computer electronic device and wherein the data transfer means includes an IEEE 1394 Serial Bus Standard digital network and wire data communication lines.

5. The security system as in claim 1 wherein
the security software includes client security software and server security software; and wherein
the at least one piece of electronic equipment comprises at least one client computer having the client security software installed thereon,
the at least one CPU comprises at least one server computer having the server security software installed thereon,
and wherein, the server security software includes:
means for determining if the at least one client computer is logged on to the network;
means for polling the at least one client computer via the data transfer means;
and wherein, the client security software includes:
means, responsive to the polling of the at least one client computer, for acknowledging the polling;
and wherein, the server security software further includes:
means for sensing the acknowledging; and
means for sending an alarm signal from the CPU to the security station in the event no acknowledging is sensed.

6. The security system as in claim 5 wherein the server security software means for sending the alarm signal further includes means for identifying a specific at least one client computer that does not acknowledge the polling.

7. The security system as defined in claim 5 wherein the data transfer means includes an ETHERNET.RTM. network and 10BaseT wiring coupling the at least one client computer and the at least one server computer to one another.

8. The security system as defined in claim 5 wherein the data transfer means includes a wireless network coupling the at least one client computer and the at least one server computer to one another.

9. A security system for detecting unauthorized disconnection of computers from a network, the security system comprising:
a plurality of server computers;
a plurality of client computers;
a security station;
data transfer means for interconnecting the plurality of server computers with the plurality of client computers and the security station;
the plurality of server computers having server security software installed thereon and the plurality of client computers having client security software installed thereon;
the server security software includes means for:
determining which of the plurality of client computers are logged on to the network;
supplying a polling signal from the plurality of server computers to polled computers via the data transfer means, wherein the polled computers include the plurality of client computers determined by the determining step to be logged on to the network;
the client security software includes means for:
responsive to the polling signal, supplying an acknowledge signal from the polled computers to the server computers via the data transfer means;
the server security software further includes means for:
receiving the acknowledge signal; and
sending an alarm signal to the security station in response to a failure to receive the acknowledge signal.

10. A security system as in claim 9 wherein the data transfer means further includes a telephonic means for interconnecting the network with the security station wherein the security station is remotely located.

11. A security system as in claim 9 wherein the data transfer means includes a wireless data communication system which interconnects the plurality of servers, the plurality of client computers, and the security station.

12. A security system as in claim 11 wherein the data transfer means further includes telephone lines which interconnect the network with the security station wherein the security station is remotely located.

13. The security system of claim 9 wherein the server security software means for supplying a polling signal from the server computers to polled computers via the data transfer means, includes means for generating the polling signal at intermittent time intervals.

14. The security system of claim 13 wherein the server security software means for determining whether the at least one client computer is logged on to the network includes:
a means for listing as logged on, the at least one client computer the determining means determines is logged on to the network;
and wherein the server security software means for supplying the polling signal at intermittent time intervals includes a means for repeatedly supplying the polling signal to each of the client computers listed as logged on.

15. The security system of claim 9 wherein the server security software means for sending an alarm signal to the security station in response to a failure to receive the acknowledge signal from a polled computer includes means for sending the alarm signal wherein the alarm signal specifically identifies which of the at least one client computer has been disconnected from the network.

16. A system as in claim 9 wherein the data transfer means for interconnecting the plurality of server computers, the plurality of client computers, and the security station includes a plurality of local area networks (LANs) interconnected to each other by bridges, and wherein the plurality of server computers comprises a plurality of local server computers and wherein the plurality of client computers includes a plurality of local client computers, each LAN including a local server and at least one local client computer interconnected by a local area network data transfer means.

17. A system as in claim 16 wherein
the server security software installed on plurality of local server computers includes:
determining means for determining if the plurality of local client computers are logged on to the network;
supplying means for supplying a polling signal from a polling local server computer to polled computers via the data transfer means, wherein the polled computers further comprise a set of local client computers selected from the plurality of local client computers, the set of local client computers including only local client computers having the same LAN as the polling local server computer;
the client security software includes means for:
responsive to the polling signal, supplying an acknowledge signal from the polled computers to the polling local server computer via the data transfer means.

18. A system as in claim 17 wherein,
the determining means of the server security further includes means for determining if the plurality of local server computers are logged on to the network; and wherein
the supplying means for supplying the polling signal from a polling local server computer to polled computers includes supplying a polling signal to polled computers wherein the polled computers further include the plurality of server computers; and wherein
the server security software installed on the plurality of server computers further includes means for:
responsive to the polling signal, the plurality of server computers, supplying an acknowledge signal to the polling computer via the data transfer means.

19. A central processing unit having server security software installed thereon, the server security software including:
means for determining if at least one piece of electronic equipment is interconnected to a network containing the central processing unit;
means for determining if the at least one piece of electronic equipment is logged on to the network;
means for polling the at least one piece of electronic equipment;
responsive to an acknowledge signal generated by the at least one piece of electronic equipment in response to the polling, the server security software further including;
means for receiving the acknowledge signal; and
means for generating an alarm signal from the central processing unit in the event no acknowledge signal is received.

20. A central processing unit as in claim 19 wherein the server security software means for generating an alarm signal includes generating an audible alarm sound.

21. A central processing unit as in claim 19 wherein the server security software means for generating an alarm signal includes generating an electronic alarm signal for transmitting to a security station.

22. A piece of electronic equipment having client security software installed thereon, the client security software including:
means for logging the electronic equipment onto a network containing a central processing unit, wherein the central processing unit includes server security software installed thereon;
means, responsive to polling initiated by the central processing unit, for acknowledging the polling, provided that the electronic equipment is logged onto the network.

23. A method for detecting unauthorized disconnection of computers from a network, the method comprising the steps of:
providing a plurality of server computers having server security software installed thereon;
providing a plurality of client computers having client server security software installed thereon;
providing a security station;
interconnecting the plurality of server computers, the plurality of client computers, and the security station with a data transfer means to form the network;
logging the plurality of client computers and the plurality of server computers onto the network;
the server security software enabling the steps of:
determining which of the plurality of client computers are logged on to the network;
polling of at least one polled computer, initiated by at least one polling computer, wherein the at least one polling computer comprises at least one of the plurality of server computers, and wherein the at least one polled computer comprises the plurality of client computers determined by the determining step to be logged on to the network;
the client security software enabling the steps:
responsive to the polling signal, supplying an acknowledge signal from the at least one polled computer to the at least one polling computer;
the server security software further enabling the steps:
receiving the acknowledge signal by the at least one polling computer; and
sending an alarm signal to the security station in response to a failure to receive the acknowledge signal from a polled computer.

24. The method of claim 23 wherein the step of interconnecting includes interconnecting the plurality of server computers, the plurality of client computers, and the security station with the data transfer means comprising telephone lines which interconnect the network with the security station wherein the security station is remotely located.

25. The method of claim 23 wherein the step of interconnecting includes interconnecting the plurality of server computers, the plurality of client computers, and the security station with a data transfer means comprising a wireless data communication system which interconnects the plurality of servers, the plurality of client computers, and the security station.

26. The method of claim 23 wherein the step of sending the alarm signal further includes sending an alarm signal which can identify the at least one client computer that did not supply an acknowledge signal.
